(19) United States
(12) Patent Application Publication
(10) Pub. No.: US 2022/0255184 A1
(43) Pub. Date: Aug. 11, 2022

(54) DEGASSING DEVICE, BATTERY, AND MOTOR VEHICLE

(71) Applicant: AUDI AG, Ingolstadt (DE)

(72) Inventors: Marvin CZECH, Ingolstadt (DE); Martin SCHÜSSLER, Kösching (DE); Thomas WITTENSCHLÄGER, Ingotstadt (DE)

(73) Assignee: AUDI AG, Ingolstadt (DE)

(21) Appl. No.: 17/666,011

(22) Filed: Feb. 7, 2022

(30) Foreign Application Priority Data
Feb. 9, 2021 (DE) 102021102908.2

(51) Int. Cl. H01M 50/35; H01M 10/613; H01M 10/625; B01D 45/04; B01D 50/20; B01D 39/20

(52) U.S. Cl. CPC H01M 50/35; H01M 10/613; H01M 10/625; H01M 2220/20; B01D 50/20; B01D 39/2041; B01D 45/04

(57) ABSTRACT

A degassing device for discharging gases from a battery for a motor vehicle, which battery includes at least one first battery cell with an at least releasable first degassing opening. The degassing device has at least one first gas space which can be fluidically coupled to the releasable first degassing opening of the at least one first battery cell, so that gas exiting the degassing opening can be introduced into the at least one first gas space, and has a particle trap device for separating particles from the gas flowing through the particle trap device. The particle trap device is fluidically connected to the at least one first gas space.

### FIELD

The invention relates to a degassing device for discharging gases from a battery for a motor vehicle, which battery comprises at least one first battery cell with an at least releasable first degassing opening. The degassing device has at least one first gas space that can be fluidically coupled to the releasable first degassing opening of the at least one first battery cell, so that gas exiting the degassing opening can be introduced into the at least one first gas space, and has a particle trap device for separating particles from the gas flowing through the particle trap device, the particle trap device being fluidically connected to the at least one first gas space. Furthermore, the invention also relates to a battery with such a degassing device and a motor vehicle with such a battery.

### BACKGROUND

Batteries, in particular high-voltage batteries, for electric or hybrid vehicles are known from the prior art. Such high-voltage batteries typically have a large number of battery cells, which can also be combined to form cell modules under certain circumstances. In the event of a defect in a battery cell, for example a short circuit, there is a risk that such a battery cell will experience thermal runaway. In the event of such a thermal runaway, the battery cell typically outgasses, with particles from the cell also being entrained in the gas flow. In order to enable such outgassing, battery cells typically have releasable degassing openings in the form of, for example, bursting membranes. The gas exiting the cells should be removed in a controlled manner so that the particles exiting a cell during outgassing cannot be deposited in the battery system in an uncontrolled manner, which can lead to blockage of flow cross-sections and short-circuiting of other cells within the battery.

For this purpose, DE 10 2018 125 446 A1 describes a battery housing for accommodating one or more battery modules with a housing section for partially delimiting the housing interior, the housing section having an integrated exhaust gas channel for discharging substances that exit a battery module if it is defective. The exhaust gas channel has at least one deflection area that is designed to change the transport direction of the substances. The deflection slows down any entrained particles. For example, sparks that could ignite the exhaust gas should be prevented from exiting the battery housing. However, there is a risk in this case as well that particles will be deposited at bottlenecks due to the deflection and thus reduce the flow cross-section or even lead to a blockage.

Furthermore, DE 10 2011 105 981 describes a lithium-ion battery defect prevention system according to which the battery cell gas is treated in the internal combustion engine exhaust system. In order to guide the battery exhaust gas to the exhaust system, a fan or air pump, among other things, is required. The problems with such active elements are that the functionality thereof cannot be guaranteed in the event of a motor vehicle accident. If these active elements are defective or functionality thereof is impaired, the battery gas cannot be discharged properly, which can have fatal consequences.

Furthermore, DE 10 201 3 204 585 A1 describes a battery pack with an overpressure release device and a particle separator. A special free space is provided in the battery pack housing for degassing, into which free space the released gas can expand and its temperature and pressure can be reduced. The gas is then released to the outside through an overpressure release device and flows through a particle separator, for example in the form of a cyclone separator or a surface filter with a fiber composite or an open-pored spongy structure. Particles contained in the gas, such as graphite dust, can be filtered out as the particles flow through the particle separator, for example to avoid explosive concentrations within the exiting gas. In this case, however, there is the problem that when the gas cools down due to expansion into the free space, numerous particles already contained in the gas are also deposited and thus do not even reach the aforementioned particle separator. In this case, too, there is again the risk of the flow path being blocked.

### SUMMARY

The object of the present invention is thus to provide a degassing device, a battery, and a motor vehicle which enable gases to be discharged from a battery cell as simply and safely as possible.

This object is achieved by means of a degassing device, a battery, and a motor vehicle.

A degassing device according to the invention for discharging gases from a battery for a motor vehicle, which battery comprises at least one first battery cell with an at least releasable first degassing opening, has a first gas space which can be fluidically coupled to the releasable first degassing opening of the at least one first battery cell, so that gas exiting the degassing opening can be introduced into the at least one first gas space. Furthermore, the degassing device comprises a particle trap device for separating particles from the gas flowing through the particle trap device, the particle trap device being fluidically connected to the at least one first gas space. The degassing device provides a first flow path from the at least one first gas space into the particle trap device, the cross-section of which is larger within at least one area of the particle trap device than in the at least one first gas space.

The invention is based on the finding that typically hundreds of battery cells with a total cell weight of approximately 2 kg cell mass are arranged in a high-voltage battery. In the event of thermal propagation of the cells of the high-voltage battery, typically 50% of the cell mass is removed by the resulting gas flow. If all battery cells of such a high-voltage battery experience thermal runaway, particles with a total weight of 1 kg mass are removed. If deposited in the wrong places in an uncontrolled manner, such a large mass of gas particles quickly leads to a complete blockage of the flow path. Due to the fact that the cross-section of the flow path according to the invention is larger within the particle trap device than in the gas space, it is advantageously possible for the flow cross-section of the gas to increase as it flows from the gas space into the particle trap device. As a result, the speed of the gas particles is reduced, which means, on the one hand, that the gas cools down and, on the other hand, that some of the particles are deposited by gravity due to their lower speed. The invention is based on the finding that a cross-sectional enlargement when the gas flows into the particle trap means that particles are deposited exactly where they are supposed to be, namely in the particle trap and not upstream in the gas space. As a result, it can advantageously be prevented that the flow path is partially or completely blocked by particles that are deposited at locations where no depositing should actually take place. In other words, this can advantageously prevent an uncontrolled depositing of particles at bottlenecks or other areas that are not intended for this. At the same time, particle separation can be forced at one of the locations provided and designed for this purpose, namely in the particle trap device. As a result, not only is a gas flow ultimately discharged from the battery which has cooled and which, as a result, entails a lower risk of self-ignition, but a dangerous blockage of the flow path can also be avoided. Another great advantage of the above-mentioned flow cross-section increase within the particle trap device is that a sufficiently large deposition space can be provided within the particle trap device at the same time, in which deposition space there is easily space to enable particles to be deposited there without blocking the flow path. The cross-sectional enlargement of the flow path when it enters the particle trap device has a dual function, so to speak, because this provides sufficient space for the particles to be deposited and, on the other hand, particle deposition is additionally promoted by reducing the flow rate. As a result, gases can be discharged safely from a battery in an especially simple and efficient manner.

The degassing device is preferably used in a battery that is designed as a high-voltage battery of a motor vehicle. Such a high-voltage battery can comprise several battery modules, each with several battery cells. These battery cells and, in particular, the at least one battery cell can be designed as lithium-ion cells, for example. An at least first releasable degassing opening of the at least one battery cell should also be understood to mean a degassing opening that is either permanently open or closed in the normal state, i.e. when the battery cell is not degassing, and only opens under certain conditions, for example when a certain pressure is reached within the first battery cell and/or a certain cell temperature is exceeded. The degassing opening of the battery cell can be designed, for example, as a bursting membrane. In order to couple the gas space to the first degassing opening, this opening can simply be arranged on a corresponding side of the battery cell, for example, so that a corresponding inlet opening of the gas space is arranged overlapping the releasable degassing opening of the first battery cell. In addition, several battery cells can also be coupled simultaneously to the gas space, in particular via respective releasable degassing openings of these several battery cells, as will be explained in more detail later.

Furthermore, a flow path is to be understood as meaning the path that a gas exiting the at least one first battery cell takes through the first gas space into the particle trap device and in particular through the particle trap device. The cross-section of the flow path is thus defined by the geometry of the cross-section of the gas space and of the particle trap device perpendicular to the flow direction of a gas.

Furthermore, it is especially advantageous if the first gas space is designed in such a way that the gas exiting a battery cell and entering the first gas space is not subjected to any expansion or at least to any strong expansion. Otherwise, the gas would hereby cool down very strongly even before entering the particle trap device, as a result of which too many particles would separate before entering the particle trap device, as a result of which a flow would possibly be impeded.

Accordingly, an especially advantageous embodiment of the invention is represented when the at least one first gas area is designed as a first degassing channel, which has a length in a longitudinal direction of extension of the first degassing channel, the gas space being greater than a width and a height of the first degassing channel, the first flow path extending along the longitudinal direction of extension of the first degassing channel. In other words, the gas space is elongated and has a correspondingly small cross-section compared to this length, which means that what was stated above can be achieved, namely that the gas does not expand too much when it exits the at least one first battery cell, as would be the case with a spatially greatly expanded gas space. By providing a degassing channel instead of a spatially very expanded gas space, it is advantageously possible to concentrate the particle separation on the particle trap device and, on the other hand, also to enable a targeted control of the gas flow. In contrast to a spatially expanded gas space, a degassing channel can be used to set a directed flow without excessive turbulence, which in turn is very beneficial for particle removal and prevents particles from being separated at undesired narrow points. The provision of a gas space as a degassing channel also has other advantages. The degassing channel is preferably made of a very temperature-resistant material, such as ceramic or steel or the like. Since this degassing channel is not especially expanded over a large area, such a temperature-stable degassing channel can be provided in an especially cost-effective and weight-saving manner. Therefore, other battery components, such as housing parts, do not have to be designed as especially temperature-resistant, since they do not come into contact with the hot gases exiting the battery cell.

A further major advantage of designing the gas space as a degassing channel is that, due to the usually very small flow cross-section of the degassing channel, an overall enormous cross-sectional enlargement, in particular by a multiple, for example by a factor of at least 5, preferably by a factor of at least 10, especially preferably by a factor of at least 20, can be provided when gas is passing into the particle trap device. Such an enormous cross-sectional enlargement of the flow cross-section of the flow path when gas is passing from the degassing channel into the particle trap device can provide extremely strong cooling and thus also especially efficient particle separation of the gas.

Furthermore, it is preferred that the particle trap device is not only designed for separating out particles by providing a flow cross-section for the flow path that is greater than the degassing channel, but that the particle trap device also has a mechanism for particle separation. According to a further, very advantageous embodiment of the invention, it is provided that the particle trap device has at least one inlet area and one outlet area, the particle trap device being designed such that the first flow path is deflected from the at least one inlet area to the outlet area several times. In other words, the particle trap device can be designed with a mechanical labyrinth for particle separation. At the same time, a cooling of the gas flow is also achieved due the several deflections of the gas flow. The cooling of the gas flow in turn causes the particles contained in the gas flow to slow down, which particles increasingly sink downwards as a result of gravity and can thus be deposited on walls or other surfaces of the particle trap device provided by this mechanical labyrinth. This therefore provides an additional separation and cooling effect, i.e. in addition to the particle separation and gas-flow cooling caused by the cross-sectional enlargement.

In the simplest case, such several deflections can be provided by the particle trap device according to the principle of a siphon. Such several deflections, however, can also be designed significantly more complexly, as in the aforementioned labyrinth. However, the widening of the cross-section described and the additional cooling and separation effect thereof make it possible to design the particle trap device overall much more simply with regard to such several deflections, in order to achieve a desired cooling and particle separation. In turn, this has a positive effect on weight and costs and, above all, on the required installation space.

In a further advantageous embodiment of the invention, the particle trap device has a particle filter which is arranged in the first flow path and is made particularly of steel wool. Such a particle filter can be provided, for example, in the form of a wadding of steel wool. Particles of the gas flowing through this particle filter are caught in such a steel wool filter, so that an efficient particle separation can also be provided here. Such a particle filter can be provided particularly in addition to the several deflections described above, or also as an alternative thereto.

All of the types of particle separation and gas-flow cooling described herein also have in common and the advantage that no active elements are required, i.e. elements that have to be operated with electricity, for example, which means that the functionality is independent of the functionality of a power supply of such components. In other words, this increases the probability that, above all in the event of an accident, an unimpaired and functional gas discharge from the battery cell is nevertheless possible. In particular, the gas discharge does not require any pumps or fans or the like. The gas follows the flow path described solely due to the geometric design of the degassing device and the outlet gas pressure. This not only makes successful gas discharge safer but also more cost-effective.

In a further, very advantageous embodiment of the invention, the degassing device has at least one second degassing channel, spatially separated from the first, which is fluidically coupled to the particle trap device and which can be fluidically coupled to a releasable second degassing opening of at least one second battery cell of the battery, so that the gas exiting the second degassing opening can be introduced into the at least one second degassing channel and guided into the particle trap device along a second flow path. Moreover, this second degassing channel can be designed as described with the first degassing channel. Furthermore, this also applies to the second battery cell and the second degassing opening thereof. This embodiment has the great advantage that separate degassing channels can be provided for different battery cells or battery cell groups, each degassing channel providing a corresponding flow path to the common particle trap device. With a respective degassing channel, i.e. for example with the first and second degassing channel, a single battery cell, in this example the first or second battery cell, does not necessarily have to be coupled, rather several first battery cells, for example, can also be coupled to the first degassing channel, and several second battery cells can be coupled to the second degassing channel. The provision of several such degassing channels in turn has several advantages. On the one hand, when there are relatively small flow cross-sections which are provided by the respective degassing channel, it can be ensured that the gas exiting the cells can still be reliably discharged without clogging or overloading the particular degassing channel. If, for whatever reason, one of the degassing channels becomes blocked, at least the gas discharge from the other degassing channels can continue to be guaranteed. However, an especially great advantage of providing several degassing channels consists, above all, in the fact that the thermal decoupling of the battery cells connected to different degassing channels can be increased. The gas flowing along the other degassing channel then does not flow over the second battery cells, for example, which are coupled to the second degassing channel. For example, if the at least second battery cell is a degassing and still intact battery cell, while the at least one first battery cell is a battery cell experiencing thermal runaway and degassing, this thermal decoupling can be used to ensure that the hot gas flowing through the first degassing channel, which hot gas is exiting the at least one first battery cell, does not immediately lead to overheating of the still intact at least one second battery cell. Thermal propagation within the entire high-voltage battery can be delayed longer with such increased thermal decoupling, which in turn greatly increases the safety of the overall system.

Furthermore, the invention also relates to a battery for a motor vehicle having a degassing device according to the invention or one of the embodiments thereof. The advantages described for the degassing device according to the invention and the embodiments thereof also apply in a corresponding manner to the battery according to the invention. The battery is preferably designed as a high-voltage battery in this case. The battery further comprises at least one battery cell, in particular the above-mentioned at least one first battery cell with the releasable first degassing opening. In addition, the battery can also comprise the above-mentioned at least one second battery cell with the releasable second degassing opening. The battery preferably comprises several battery modules, each with at least one battery cell, preferably with several battery cells each.

It is a further, very advantageous embodiment of the battery if the battery has a first battery area with at least one first row of cells with several first battery cells arranged next to one another in a first direction and each having releasable first degassing openings, and a second battery area with at least one second row of cells with several second battery cells arranged next to one another in the first direction, each battery cell of which has releasable second degassing openings, the particle trap device being arranged between the first battery area and the second battery area with respect to the first direction, and the first degassing channel being coupled to the releasable first degassing openings of the first battery cells and extending in the first direction with respect to the particle trap device, and the second degassing channel being coupled to the releasable second degassing openings of the second battery cells and extending opposite the first direction with respect to the particle trap device.

In other words, the particle trap device can extend centrally between the first and second battery areas. The respective degassing channels accordingly extend on both sides of this central particle trap device in the direction opposite the particle trap device. The outlet opening, from which the gas flow finally exits the battery cell or the motor vehicle, can be arranged outside the battery or in an edge region of the battery. Due to the relatively centrally arranged particle trap device, it is advantageously possible for the gas that exits, for example from a battery cell that is also arranged in an edge region of the battery, to first be routed to the center of the battery with respect to the particle trap device via the corresponding degassing channel, then through the particle trap device, and then in turn to lead away from the particle trap device to the spatial region of the battery to the final outlet opening. As a result, the gas exiting a battery cell covers a very long distance, which has the great advantage that the gas can also cool down due to this long distance. In this case, additional particles can also be deposited along the path. This separation takes place relatively uniformly along a very long path, so that there is no severe narrowing of the channel cross-section in places due to uncontrolled particle separation. The described geometric arrangement of the particle trap device between the two battery areas and the degassing channels leading to this central particle trap device can further increase the safety of the gas discharge from the battery.

The first row of cells with several first battery cells can particularly also comprise several battery modules, which in turn have the several first battery cells. The same thing applies to the second row of cells. In addition, the first battery area can also have several of such cell rows, which extend parallel to one another in the first direction, for example. The second battery area can also have several second cell rows, all of which extend in the direction opposite the first direction and can also be arranged parallel to one another. These several first and second rows of cells can, for example, be arranged next to one another in a second direction, in which the particle trap device extends in its longitudinal direction of extension. An elongated particle trap device can thus advantageously be provided in a space-efficient manner, through which a widening of the cross-section can then be accomplished in an especially simple manner when the gases pass from the gas channels or degassing channels into the particle trap device.

In a further advantageous refinement of the battery according to the invention, the battery has a cooling base on which the at least one first battery cell is arranged, and the degassing device has an exhaust gas channel which is coupled to the outlet opening of the particle trap device, the exhaust gas channel being arranged on a side of the cooling base facing away from a battery cell, the exhaust gas channel particularly being provided by a spatial region between the cooling base and the underbody protection. In other words, the gas exiting the battery cells can be routed, via the respective degassing channels, into the particle trap device and, after passing therethrough, introduced into the exhaust gas channel through which the gas is discharged from the battery and particularly from the motor vehicle. It is especially advantageous if the exhaust gas channel is provided by a spatial region between the cooling base and the underbody protection of the motor vehicle, since existing structures in the vehicle can thus be used, which is especially efficient in implementation. Furthermore, an additional exhaust gas channel, which can optionally be implemented through existing structures, can be used to ensure that the gas ultimately has to cover a longer distance before exiting the battery or the vehicle, whereby the gas can be further cooled. Alternatively or additionally, the gas can also be guided through chambers of the extruded profiles that form the battery housing, so that such chambers take over the function of the exhaust gas channel mentioned. Particles can continue to be deposited here without posing a potential risk.

Furthermore, the invention also relates to a motor vehicle having a battery according to the invention or one of the designs thereof.

The motor vehicle according to the invention is preferably designed as an electric vehicle or as a hybrid vehicle. In addition, the motor vehicle according to the invention is preferably designed as an automobile, in particular as a passenger car or truck, or as a passenger bus or motorcycle.

The invention also comprises combinations of the features of the described embodiments. The invention thus also comprises implementations that each have a combination of the features of several of the described embodiments, provided that the embodiments were not described as mutually exclusive.

### BRIEF DESCRIPTION OF THE FIGURES

Exemplary embodiments of the invention are described hereinafter. The figures show the following:

FIG. 1 a schematic cross-sectional representation of a battery with a degassing device according to an exemplary embodiment of the invention; and

FIG. 2 a schematic plan view of a battery with a degassing device according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those illustrated. Furthermore, the described embodiments can also be supplemented by further, above-described features of the invention.

In the figures, the same reference numerals designate elements that have the same function.

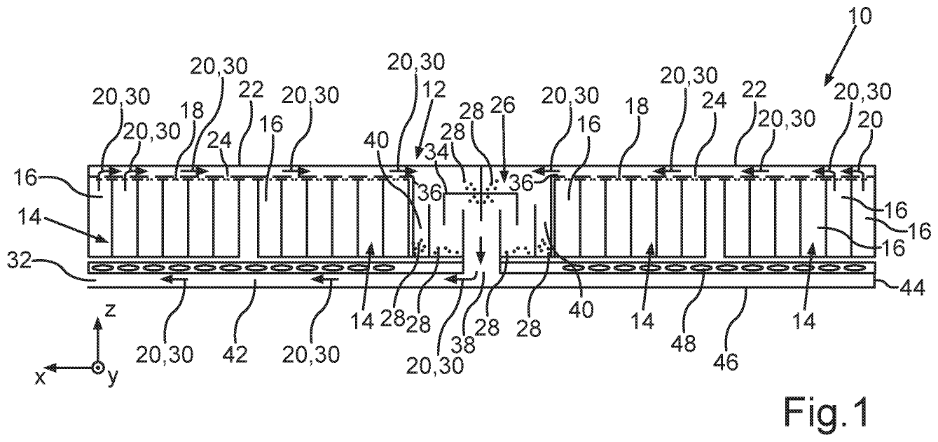

FIG. 1 shows a schematic cross-sectional representation of a battery 10, in particular a high-voltage battery 10, for a motor vehicle with a degassing device 12 according to an exemplary embodiment of the invention. In this example, the battery 10 has several battery modules 14 each with several battery cells 16. For reasons of clarity, only a few of the battery cells 16 in this case are provided with a reference numeral. Four battery modules 14 are shown here as an example. The battery 10 can generally also comprise more or fewer battery modules, and in particular also more or fewer battery cells 16.

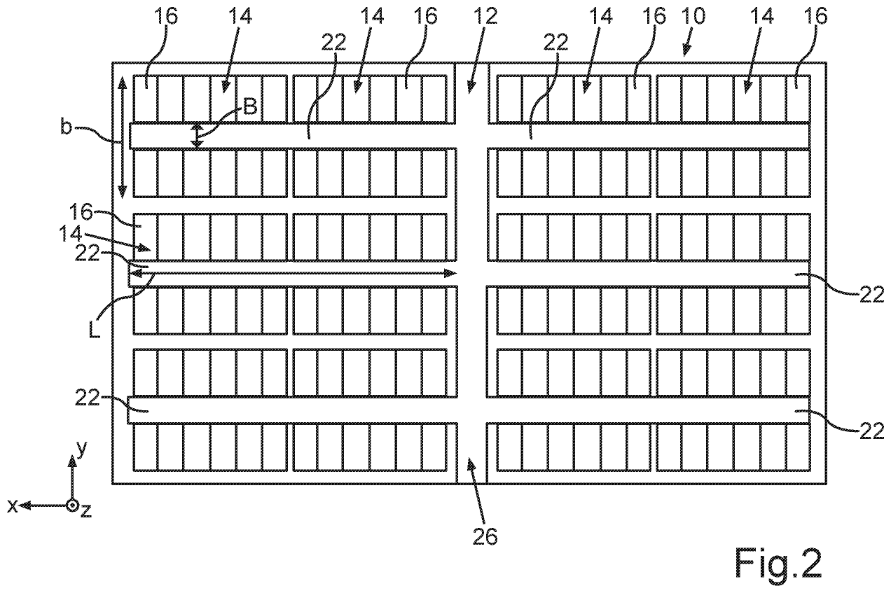

FIG. 2 shows the associated plan view of the battery 10, in particular without the housing cover, some of the battery modules 14 and the battery cells 16 thereof being provided with a reference numeral here as an example for reasons of clarity.

If a battery cell 16 is experiencing thermal runaway, gases are produced inside such a battery cell 16, which gases must be discharged in a controlled manner in order to prevent these battery cells 16 from exploding. For this purpose, the respective battery cells 16 have a releasable degassing opening 18, which can be designed as a bursting membrane, for example. In FIG. 1, these releasable degassing openings 18 are indicated by dashed lines on the upper side of the respective battery cells 16, with only some of these degassing openings 18 being provided with a reference numeral in turn for reasons of clarity. The gases 20 exiting the battery cells 16 are also illustrated by arrows. Gases 20 exiting a battery cell 16 are initially extremely hot and comprise material particles, such as dust, which, if the materials were to accumulate at bottlenecks in or outside the battery system in an uncontrolled manner, could lead, for example, to a blockage of flow cross-sections and/or short-circuiting of other cells 16 within the battery 10. In order to prevent this, the battery 10 advantageously has a degassing device 12. This comprises, on the one hand, degassing channels 22. In general, the degassing device 12 has at least one such degassing channel 22 which can be fluidically coupled to the degassing openings 18 of the battery cells 16, so that the gas flow 20 exiting the degassing openings 18 can be routed or introduced into such a degassing channel 22. This can be accomplished in a simple manner by the degassing channel 22 being arranged above the battery cells 16 in relation to the z-direction shown and having corresponding channel openings 24 which are arranged to overlap with the respective degassing openings 18 of the battery cell 16. Furthermore, this degassing channel 22 is designed to be as narrow as possible, so that the width B (see FIG. 2) thereof is preferably smaller than a module width b and also smaller than a length L of such a degassing channel 22. In particular, the length L of such a degassing channel 22 should represent the greatest dimension of such a degassing channel. Furthermore, the degassing device 12 comprises a particle trap device 26 which is designed to separate particles from the gas 20 flowing through the particle trap device 26. Such separated particles 28 are shown as an example in FIG. 1. This particle trap device 26 is also fluidly connected to the respective degassing channels 22. A flow path 30 is thus provided, which defines the path followed by the gas 20 flowing out of the battery cells 16, so that this flow path 30 can also be considered illustrated by the arrows shown in FIG. 1 in the same manner. This flow path 30 thus extends from the cells 16, through the degassing channels 22, to the particle trap device 26, and through this to a final outlet opening 32.

The flow path 30 is advantageously designed in such a way that the flow cross-section increases at the transition from the degassing channels 22 to the particle trap device 26, in particular by a multiple, for example by a factor of 20. For example, the cross-section of a degassing channel, i.e. a section parallel to the yz-plane in this example, can be 4 cm² and the cross-sectional area of the particle trap device 26 in the same cross-sectional plane, i.e. again parallel to the yz-plane, can be 80 cm². Due to the fact that the particle trap device 26 is elongated in the y-direction, as can be seen above all in FIG. 2, such a large cross-sectional area of the particle trap device 26 can be provided in an especially simple manner. A cross-sectional enlargement from the degassing channel 22 to the particle trap device 26 can be used by all the degassing channels 22 in the same manner. Such a cross-sectional enlargement has the great advantage that the gas 20 can be cooled again as a result, which promotes particle separation. In addition, the fact that the degassing channels 22 themselves are designed with a relatively small cross-section in the direction of flow 30 ensures that the gas 20 does not expand particularly strongly when it exits the battery cells 16 and thus does not cool down significantly in the degassing channels 22 themselves, which means that uncontrolled depositing of particles 28 within the degassing channels 22 can be avoided or at least reduced before the particle trap device 26 is reached. This means that the particles 28 are only separated where there is sufficient space for this, namely in the particle trap device 26.

Furthermore, the particle trap device 26 is designed with a labyrinth system 34 in this example. Such a labyrinth system 34 causes several deflections of the flow path 30 from an inlet opening 36, particularly the several inlet openings 36 assigned to the respective degassing channels 22, to the outlet opening 38 of the particle trap device 26. This labyrinth structure or this labyrinth system 34 can also have dead ends 40, which can likewise be used for increased particle separation. Such a mechanical deflection and labyrinth structure also promotes particle separation in addition to the widening of the cross-section. The particle trap device 26 can also have other or additional devices for particle separation, for example a filter-like wadding made of steel wool. Sparks above all can hereby be efficiently filtered out.

The gas finally exiting the outlet opening 38 of the particle trap device 26 has therefore cooled down considerably and now contains only a few particles, which, however, are largely harmless in terms of possible ignition of the exiting gas due to the low speed and low temperature thereof. Furthermore, an exhaust gas channel 42 is coupled to the outlet opening 38 of the particle trap device 26, via which exhaust gas channel the exiting gas 20 can be discharged from the battery 10 and from the motor vehicle as far as the final outlet opening 32. As a result, the gas 20 has to cover a longer distance before it exits the opening 32, which leads to an additional slowing down and cooling of the gas 20.

It is also especially advantageous if this exhaust gas channel 42 is provided by an existing structure of the battery 10 and/or of the motor vehicle. In this example, the exhaust gas channel 42 is provided by an intermediate space that is located between a cooling base 44 of the battery 10 for cooling the battery cells 16 and the underbody protection 46 of the motor vehicle. The cooling base 44 can also have cooling channels 48 through which a coolant can flow. In addition, this intermediate space providing the exhaust gas channel 42 can extend over the entire x-y-plane of the battery 10.

Overall, the examples show how the invention can provide a particle trap in a high-voltage battery, which particle trap makes it possible to discharge a gas exiting the battery cells in an especially simple and safe manner in the event of thermal propagation.

1. A degassing device for discharging gases from a battery of a motor vehicle, comprising:
at least one first gas space which can be fluidically coupled to a releasable first degassing opening of at least one first battery cell, so that gas exiting the first degassing opening can be introduced into the at least one first gas space, and
a particle trap device for separating particles from the gas flowing through the particle trap device, wherein the particle trap device is fluidically connected to the at least one first gas space,
wherein the degassing device provides a first flow path from the at least one first gas space into the particle trap device, the cross-section of which is larger within at least one area of the particle trap device than in the at least one first gas space.

2. The degassing device according to claim 1, wherein the at least one first gas space is designed as a first degassing channel, which has a length (L) in a longitudinal direction of extension (x) of the first degassing channel that is greater than a width (B) and a height of the first degassing channel, wherein the first flow path extends along the longitudinal direction of extension (x) of the first degassing channel.

3. The degassing device according to claim 1, wherein the particle trap device is designed to cool a gas flow passing through the particle trap device as it passes through.

4. The degassing device according to claim 1, wherein the particle trap device has at least one inlet area and one outlet area, wherein the particle trap device is designed in such a way that the first flow path is deflected several times from at least one inlet area to the outlet area.

5. The degassing device according to claim 1, wherein the particle trap device has a particle filter arranged in the first flow path, in particular made of steel wool.

6. The degassing device according to claim 1, further comprising at least one second degassing channel, spatially separated from the first, which is fluidically coupled to the particle trap device and which can be fluidically coupled to a releasable second degassing opening of at least one second battery cell of the battery, so that the gas exiting the second degassing opening can be introduced into the at least one second degassing channel and guided into the particle trap device along a second flow path.

7. A battery for a motor vehicle, comprising: a degassing device having at least one first gas space which can be fluidically coupled to a releasable first degassing opening of at least one first battery cell, so that gas exiting the first degassing opening can be introduced into the at least one first gas space, and a particle trap device for separating particles from the gas flowing through the particle trap device, wherein the particle trap device is fluidically connected to the at least one first gas space, wherein the degassing device provides a first flow path from the at least one first gas space into the particle trap device, the cross-section of which is larger within at least one area of the particle trap device than in the at least one first gas space.

8. The battery according to claim 7, further comprising a first battery area with at least one first row of cells with several first battery cells arranged next to one another in a first direction (x), which battery cells each have releasable first degassing openings, and a second battery area with at least one second row of cells with several second battery cells arranged next to one another in the first direction, which battery cells each have releasable second degassing openings, wherein the particle trap device is arranged between the first battery area and the second battery area with respect to the first direction (x), wherein the first degassing channel is coupled to the releasable first degassing openings of the first battery cells and extends in the first direction (x) with respect to the particle trap device, and the second degassing channel is coupled to the releasable second degassing openings of the second battery cells and extends opposite the first direction (x) with respect to the particle trap device.

9. The battery according to claim 8, further comprising a cooling base on which the at least one first battery cell is arranged, and the degassing device has an exhaust gas channel which is coupled to the outlet opening of the particle trap device, wherein the exhaust gas channel is arranged on a side of the cooling base facing away from the at least one battery cell, in particular wherein the exhaust gas channel is provided by a spatial region between the cooling base and the underbody protection.

10. A motor vehicle comprising: a battery with a degassing device having at least one first gas space which can be fluidically coupled to a releasable first degassing opening of at least one first battery cell, so that gas exiting the first degassing opening can be introduced into the at least one first gas space, and a particle trap device for separating particles from the gas flowing through the particle trap device, wherein the particle trap device is fluidically connected to the at least one first gas space, wherein the degassing device provides a first flow path from the at least one first gas space into the particle trap device, the cross-section of which is larger within at least one area of the particle trap device than in the at least one first gas space.

11. The degassing device according to claim 2, wherein the particle trap device is designed to cool a gas flow passing through the particle trap device as it passes through.

12. The degassing device according to claim 2, wherein the particle trap device has at least one inlet area and one outlet area, wherein the particle trap device is designed in such a way that the first flow path is deflected several times from at least one inlet area to the outlet area.

13. The degassing device according to claim 3, wherein the particle trap device has at least one inlet area and one outlet area, wherein the particle trap device is designed in such a way that the first flow path is deflected several times from at least one inlet area to the outlet area.

14. The degassing device according to claim 2, wherein the particle trap device has a particle filter arranged in the first flow path, in particular made of steel wool.

15. The degassing device according to claim 3, wherein the particle trap device has a particle filter arranged in the first flow path, in particular made of steel wool.

16. The degassing device according to claim 4, wherein the particle trap device has a particle filter arranged in the first flow path, in particular made of steel wool.

17. The degassing device according to claim 2, further comprising at least one second degassing channel, spatially separated from the first, which is fluidically coupled to the particle trap device and which can be fluidically coupled to a releasable second degassing opening of at least one second battery cell of the battery, so that the gas exiting the second degassing opening can be introduced into the at least one second degassing channel and guided into the particle trap device along a second flow path.

18. The degassing device according to claim 3, further comprising at least one second degassing channel, spatially separated from the first, which is fluidically coupled to the particle trap device and which can be fluidically coupled to a releasable second degassing opening of at least one second battery cell of the battery, so that the gas exiting the second degassing opening can be introduced into the at least one second degassing channel and guided into the particle trap device along a second flow path.

19. The degassing device according to claim 4, further comprising at least one second degassing channel, spatially separated from the first, which is fluidically coupled to the particle trap device and which can be fluidically coupled to a releasable second degassing opening of at least one second battery cell of the battery, so that the gas exiting the second degassing opening can be introduced into the at least one second degassing channel and guided into the particle trap device along a second flow path.

20. The degassing device according to claim 5, further comprising at least one second degassing channel, spatially separated from the first, which is fluidically coupled to the particle trap device and which can be fluidically coupled to a releasable second degassing opening of at least one second battery cell of the battery, so that the gas exiting the second degassing opening can be introduced into the at least one second degassing channel and guided into the particle trap device along a second flow path.
